(19) United States
(12) Patent Application Publication
(10) Pub. No.: US 2016/0127224 A1
(43) Pub. Date: May 5, 2016

(54) ELECTING DESIGNATED ROUTING BRIDGE

(71) Applicant: HANGZHOU H3C TECHNOLOGIES CO., LTD., Hangzhou, Zhejiang (CN)

(72) Inventor: Yuening WANG, Beijing (CN)

(73) Assignee: HANGZHOU H3C TECHNOLOGIES CO., LTD., Hangzhou City (CN)

(21) Appl. No.: 14/892,422

(22) PCT Filed: Jul. 10, 2014
(86) PCT No.: PCT/CN2014/081934

§ 371 Date: Nov. 19, 2015

(30) Foreign Application Priority Data
Jul. 16, 2013 (CN) 201310300901.8

(51) Int. Cl. H04L 12/753; H04L 29/08; H04L 12/46; H04L 12/751

(52) U.S. Cl. CPC H04L 45/48; H04L 45/026; H04L 69/324; H04L 12/4625; H04L 12/4641

(57) ABSTRACT

According to an example, a RB sends an election packet to a STP device to cause the STP device to flood the election packet in a spanning tree. The RB may receive a second election packet and perform DRB election based on the second election packet.

### BACKGROUND

TRILL (transparent interconnection of lots of links) is a routing protocol that introduces ISIS (intermediate system-to-intermediate system) into the link layer to implement a link state-based autonomous system on the link layer. TRILL is a new substitute for STP (spanning tree protocol). TRILL introduces layer-3 routing techniques into layer-2 networks to address issues of STP such as wasting link bandwidth, forwarding data not using optimal paths, not supporting link load balancing, broadcast storm in temporary loops, too large MAC (media access control) tables, and the like.

A device running TRILL is referred to as an RB (routing bridge). When devices in a broadcast network are interconnected in a full mesh manner, endless exchanging of link state information will result in waste of network resources. In order to improve the situation, the TRILL protocol defines a DRB (designated routing bridge) for issuing pseudo node LSP (link state PDU (protocol data unit)) packets to simplify the logical topology of the broadcast network. A DRB may also designate for each VLAN (virtual local area network) an AVF (appointed VLAN-x forwarder) so that packets related with a VLAN (including packets sent by the VLAN and packets destined for the VLAN) have a unified entrance and exit on each link, and other RBs that receive the packets will neglect the packets.

RBs maintain respective AVF to ensure that packets are forwarded properly. When an RB receives a hello packet sent by another RB which claims to be the AVF of a VLAN, the RB will perform AVF inhibiting to facilitate correct transmission of packets.

### BRIEF DESCRIPTION OF THE DRAWINGS

Features of the present disclosure are illustrated by way of example and not limited in the following figures, in which like numerals indicate like elements, in which:

FIG. 1 is a schematic diagram illustrating RB1 connected with a local network;

FIG. 2 is a schematic diagram illustrating RB2 connected with a local network;

FIG. 3 is a schematic diagram illustrating a network generated by merging of the two local networks as shown in FIG. 1 and FIG. 2;

FIG. 4 is a flowchart illustrating a method of electing DRBs in accordance with an example of the present disclosure;

FIG. 5 is a schematic diagram illustrating a format of a packet for delivering a result of AVF designation in accordance with an example of the present disclosure;

FIG. 6 is a schematic diagram illustrating modules of an apparatus in accordance with an example of the present disclosure; and

FIG. 7 is a schematic diagram illustrating modules of an apparatus in accordance with an example of the present disclosure.

### DETAILED DESCRIPTIONS

For simplicity and illustrative purposes, the present disclosure is described by referring mainly to some examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

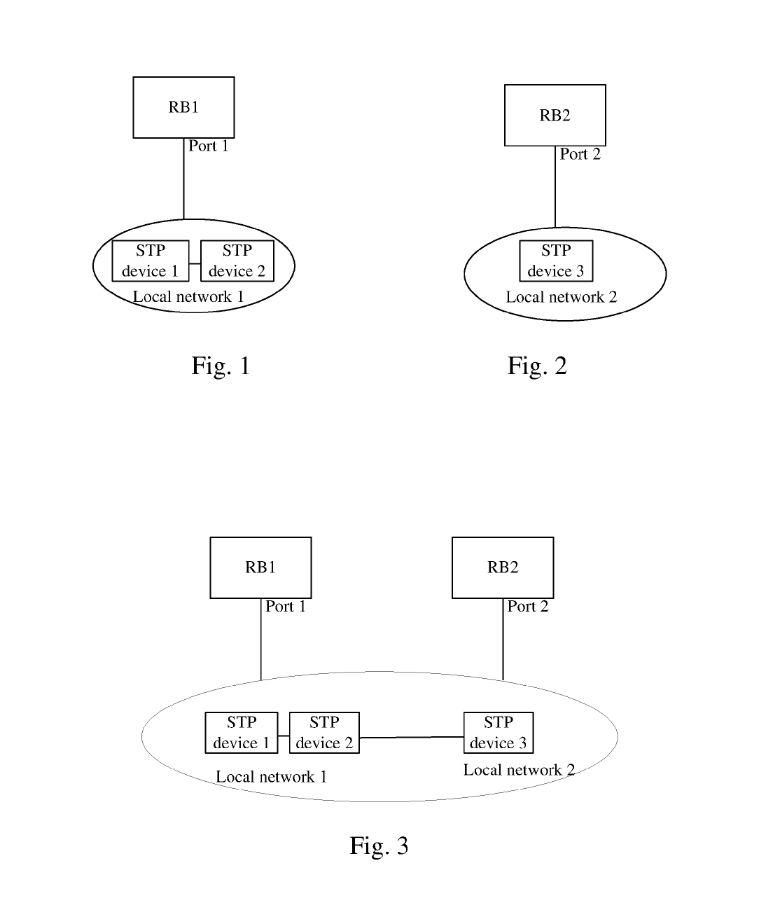

FIG. 1 is a schematic diagram illustrating RB1 connected with a local network. Port1 of RB1 in FIG. 1 is the AVF of VLAN-1 of the local network. FIG. 2 is a schematic diagram illustrating RB2 connected to a local network. Port2 of RB2 is the AVF of VLAN-1 of local network 2. The two RBs act as the AVF of VLAN-1 and forward traffic for VLAN-1 in respective local networks. The local network may be an STP (Spanning Tree Protocol) network, e.g., a regular STP network, or an MSTP (Multiple Spanning Tree Protocol) network, or an RSTP (Rapid Spanning Tree Protocol) network, or other types of STP networks.

FIG. 3 is a schematic diagram illustrating a network formed from merging of the two local networks as shown in FIG. 1 and FIG. 2. According to FIG. 3, when the two local networks merge with each other, STP devices in the network may re-elect a root bridge for the local network. At the same time, an AVF conflict may occur because RB1 and RB2 are both the AVF of VLAN-1 in the merged network. An RB may apply inhibiting on an edge port, i.e., the port connected to the local network, within all of VLANs in which the edge port serves as the AVF if the RB first receives an STP packet indicating the root bridge has been changed via the edge port. The RB may, alternatively, perform inhibiting on the edge port in a VLAN in which an AVF conflict occurs if the RB first receives a packet indicating the AVF conflict, and may perform inhibiting in all of VLANs in which the edge port serves as the AVF after an STP packet indicating the root bridge has been changed. In an example, the STP devices may be MSTP devices.

At present, when performing inhibiting, an RB may send a TRILL hello packet repetitively in all of VLANs in which an edge port of the RB serves as the AVF for DRB re-election and AVF re-designation to ensure proper transmission of VLAN packets. The TRILL hello packets are transmitted in the MSTP network as regular data packets. But within a certain time period after the merge of the two local networks, the network topology is re-calculated. The topology re-calculation makes the MSTP network unstable, and the TRILL hello packets sent by an edge port of an RB as regular multicast data packets may not be properly forwarded in the merged MSTP network. It is not until the MSTP network becomes stable or an AVF inhibiting time expires that the RB can continue sending the TRILL hello packets, the DRB re-election can be performed, and the AVF of the VLAN can be determined by the elected DRB. Only after that can the network transmit packets for VLANs as normal.

Therefore, when two local networks merge, two RBs that are connected to the two MSTP networks need to wait for the local network becomes stable to perform DRB election and AVF designation. It usually takes a long time before the MSTP network becomes stable, so the AVF designation can only be done after a long time, and the VLAN traffic will be kept interrupted for a long time.

Various examples of the present disclosure provide a method of electing DRBs. The method is applicable to any RB that is connected to a local network when multiple STP networks in a TRILL network merge with each other. When the RB applies AVF inhibiting to an edge port, packets for electing a DRB is sent and received through flooding by STP devices in spanning trees. As such, DRB election can be performed by using the packets for electing a DRB before the merged STP network becomes stable. When AVF inhibiting is applied to an edge port, a DRB can be elected in a short time. AVFs may be designated by the elected DRB and be ready to forward VLAN traffic as long as the merging of STP networks finishes. Thus, the time of the VLAN traffic being interrupted may be reduced.

The present disclosure illustrates the principles discussed herein by taking several examples applied to an MSTP network. In other examples, the same approach may be applied to other types of STP networks.

According to an example, when AVF inhibiting is applied to an edge port of an RB, the AVF inhibiting may be applied to a VLAN in which an AVF conflict occurred, or to all of VLANs in which the edge port serves as the AVF.

When the RB receives an STP packet via an edge port from an STP device in the STP network indicating the root bridge of the STP device has changed, the RB may apply AVF inhibiting to all of VLANs in which the edge port serves as an AVF.

When the RB receives a packet indicating an AVF conflict via the edge port, the RB applies AVF inhibiting to a VLAN in which the AVF conflict occurs. If an STP packet indicating a root bridge has changed is received after receiving the packet indicating the AVF conflict, the RB may apply AVF inhibiting to all the VLANs in which the edge port serves as the AVF.

The edge port of the RB refers to the port of the RB that is connected to the local network. For instance port 1 is the edge port of RB1 in FIG. 1 and port 2 is the edge port of RB2 in FIG. 2. When two separate STP networks connected to a TRILL network are merged, AVF inhibiting is applied to the edge ports of the RBs which connect the STP networks to the TRILL network. For instance, FIG. 3 shows the situation wheres local network 1 of FIG. 1 is merged with local network 2 of FIG. 2. In this case AVF inhibiting is applied to edge port 1 of RB1 and edge port 2 of RB2, because the edge ports both serve as the designated forwarder of the same VLAN. Various examples can implement quick election of DRBs when AVF inhibiting is applied to an edge port of an RB, and the elected DRB designates an AVF for each VLAN. As such, the time of VLAN traffic being interrupted resulted from the AVF inhibiting of the edge port can be reduced.

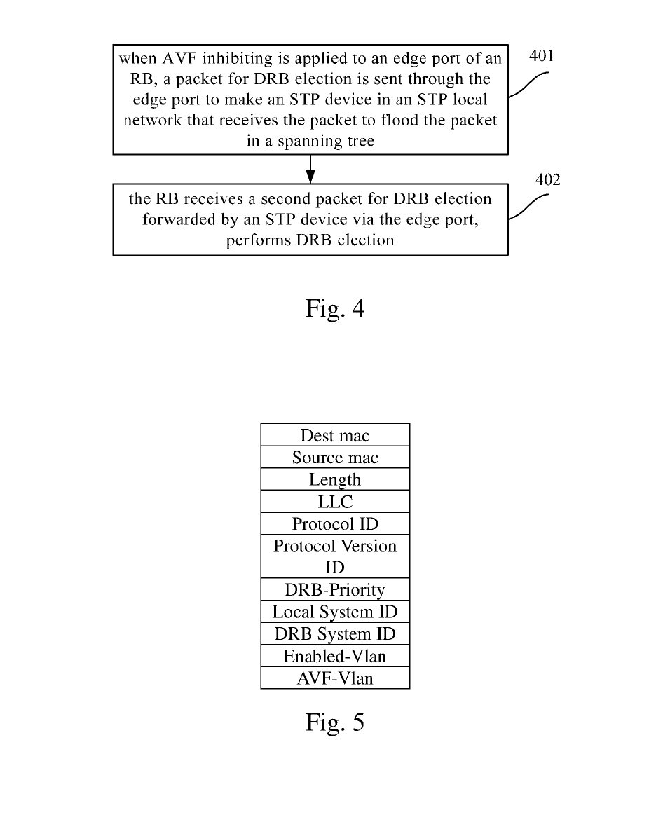

The following is an example of the DRB election process during the merging process of local networks. While the example in FIG. 4 refers to MSTP (Multiple Spanning Tree Protocol), similar processes can be applied to other types of spanning tree networks such as STP networks or RSTP (Rapid Spanning Tree Protocol) networks. Unless stated otherwise, where the term STP is used in the description or claims, it is used a general sense to mean STP, RSTP or MSTP.

FIG. 4 is a flowchart illustrating a method of electing DRBs in accordance with an example of the present disclosure.

At block 401, when AVF inhibiting is applied to an edge port of an RB, the RB sends a packet for electing a DRB (hereinafter simply referred to as election packet) via the edge port to cause an STP device in the local network that receives the election packet to flood the election packet in a spanning tree. For example, the STP device may be an MSTP device, and the STP device may flood the election packet in a CIST (Common and Internal Spanning Tree).

The RB is an RB that is connected to one of the MSTP networks in a TRILL network that are merging. Suppose the edge port of the RB and edge ports of other RBs that are connected to other MSTP networks are designated as the AVF of the same VLAN. An edge port of an RB refers to a port that is connected to a local network.

In an example, the RB may send the election packet again after a certain time interval. The transmission time intervals of the election packet may have the same duration, or different durations as needed. In an example, the RB may set up a threshold of the number of transmission times. When the election packet has been sent for a number of times that reaches the threshold, the election packet is not to be sent any more.

In an MSTP network, spanning trees include an IST (Internal Spanning Tree) and a CST (Common Spanning Tree). Therefore, when an election packet is flooded by MSTP devices in an MSTP network, the election packet is flooded in the CIST.

As shown in FIG. 3, port1 of RB1 and port2 of RB2 are edge ports, and are both the AVF of VLAN-1. When the local network connected with RB1 merges with the MSTP network connected with RB2, an AVF conflict of RB1 and RB2 occurs. The AVF conflict results in AVF inhibiting on edge ports of the RBs, and necessitates DRB re-election and AVF designation to enable forwarding of VLAN traffic. The RB in this procedure may be replaced with RB1 or RB2 in FIG. 3.

When AVF inhibiting is applied to an edge port of an RB, the RB may serve as a DRB and send a TRILL hello packet via the edge port according to a conventional scheme. The TRILL hello packet, however, will not be received by other RBs as a regular multicast data packet due to the instability of the network during the network merging process. According to various examples, the TRILL hello packet may be sent according to the conventional scheme when multiple local networks merge with each other. After a DRB is elected according to the scheme provided by the examples, the TRILL hello packet may still be sent to maintain neighborhood relations, and the conventional mechanism regarding the TRILL hello packet is not modified or influenced.

After receiving the election packet sent by the RB via the edge port, an MSTP device floods the election packet in the CIST, i.e., the election packet is transparently transmitted in the whole network. When forwarding the election packet, the MSTP device may forward the election packet via all of ports except the port from which the election packet was received, as long as the ports are up in the physical layer no matter whether the STP status of the ports is the forwarding status. As such, the whole network can receive any election packets sent by any RB. The MSTP device refers to an MSTP device that has enabled functions of flooding the election packet.

The election packet sent by the RB may include packet identification information for facilitating an MSTP device to identify the packet as an election packet. Thus, when an MSTP device receives a packet which includes the packet identification information, the MSTP device may flood and transparently transmit the packet. The packet identification information may be a pre-defined ID which is identifiable to represent the type of election packets or the like, and this is not limited by the present disclosure.

At block 402, the RB receives an election packet forwarded by an STP device, e.g., an MSTP device, via an edge port, and performs DRB election.

After an election packet flooded by an MSTP device from another RB is received, the RB may perform DRB election.

In an example, an election packet sent by an RB may include a priority of the local RB (i.e., the RB that initiated the election packet), a DRB system ID which is the system ID of a DRB elected by the local RB, and a local system ID which is the system ID of the local RB. RBs may use the information in DRB election. In an election packet of an RB, the DRB system ID is initially set to be the local system ID, i.e., the system ID of the local RB. The procedure in block 402 may include the following process.

After receiving an election packet, the RB compares the priority in the election packet with a priority of the RB.

In response to a determination that the priority in the election packet is larger than the priority of the RB, the RB determines the RB is not a DRB, and updates a DRB system ID in a stored election packet of the RB with the local system ID in the received election packet, and sends the stored election packet immediately. In an example, each RB may send an election packet for multiple times, and each RB may store a copy of an election packet generated by the RB itself When an RB needs to send an election packet, the RB may generate a copy of the stored election packet, and send the copy.

In response to a determination that the priority in the received election packet is smaller than the priority of the RB, the RB determines the RB is the DRB and continues to send the election packet of the RB. The DRB system ID in the election packet of the RB is still the local system ID of the RB.

In response to a determination that the priority in the received election packet is identical to the priority of the RB, the RB may judge whether the local system ID in the received election packet is larger than the local system ID of the RB. In response to a determination that the local system ID in the received election packet is larger than the local system ID of the RB, the RB updates the DRB system ID in the election packet of the RB with the local system ID in the received election packet and sends the election packet of the RB. In response to a determination that the local system ID in the received election packet is smaller than the local system ID of the RB, the RB continues to send the election packet of the RB.

When two RBs have the same DRB priority, the DRB can be determined based on the local system IDs of the RBs. Since RBs within the network have different system IDs, only one DRB can be determined

In an example, an election packet sent by an RB may include a local priority which is the priority of the local RB, a local system ID, a DRB priority which is the priority of an DRB elected by the local RB, and a DRB system ID which is the system ID of the elected DRB. In the election packet of an RB, the DRB priority has an initial value of the priority of the local RB, and the DRB system ID has an initial value of the local system ID. The procedure in block 402 may include the following process.

After receiving an election packet, the RB compares the DRB priority in the received election packet with the DRB priority in the election packet of the RB.

In response to a determination that the DRB priority in the received election packet is larger than the DRB priority in the election packet of the RB, the RB updates the DRB priority in the election packet of the RB with the DRB priority in the received election packet, updates the DRB system ID in the election packet of the RB with the DRB system ID in the received election packet, and sends the election packet.

In response to a determination that a DRB elected by another RB is of higher priority than the DRB elected by the RB, the RB may take the DRB elected by the another RB as the DRB elected by the RB, thus the RB needs to modify the DRB priority and the DRB system ID in the election packet of the RB to be the DRB priority and the DRB system ID in the received election packet. After several comparisons, the election packet sent by the RB may include the DRB priority and the DRB system ID of an RB that is of the highest priority.

In response to a determination that the DRB priority in the received election packet is smaller than the DRB priority in the election packet of the RB, the RB makes no modifications to the election packet of the RB, and continues to send the election packet of the RB. In response to a determination that the RB is of higher priority of another RB, the local system ID in the election packet of the RB is still the DRB system ID.

In response to a determination that the DRB priority in the received election packet is identical to the DRB priority in the election packet of the RB, the RB may judge whether the DRB system ID in the received election packet is larger than the DRB system ID in the election packet of the RB. In response to a determination that the DRB system ID in the received election packet is larger than the DRB system ID in the election packet of the RB, the RB may update the DRB system ID in the election packet of the RB with the DRB system ID in the received election packet and sends the election packet. In response to a determination that the DRB system ID in the received election packet is smaller than the DRB system ID in the election packet of the RB, the RB may continue to send the election packet of the RB.

When two RBs have identical DRB priority, the local system IDs of the two RBs can be used to determine the DRB. Since RBs within the network have different system IDs, only one DRB can be determined

In an example, when an MSTP device in the MSTP network receives an election packet that is identical to a previously received packet, the MSTP device may not flood the election packet to reduce unnecessary flooding of packets and avoid generating a loop. In an example, an MSTP device may record information obtained from a received election packet, e.g., a source MAC address, a local priority, a DRB priority, a local system ID, a DRB system ID, and the like. When the MSTP device receives an election packet, the MSTP device may judge whether the received election packet include the same information with the information recorded in the MSTP device. In response to a determination that the election packet includes the same information with the information recorded in the MSTP device, the MSTP device may not flood the election packet. In response to a determination that the election packet includes information different from the information recorded in the MSTP device, the MSTP device may flood the election packet in a CIST.

In an example, an aging mechanism may be applied to the recorded information of election packets to conserve resources. When the aging time arrives, recorded information of election packets is deleted.

The quick election of DRB according to examples is for designating an AVF for each VLAN from among all edge ports that are connected to the local network and have the VLAN enabled. Therefore, the DRB is elected from a link (e.g., a point-to-point link or a tree-shaped link connecting multiple nodes) connecting the edge ports via the local network, i.e., the DRB is elected within the link that connect the RB ports via the local network, there is only one RB that can be elected as the DRB within each link, and the DRB is an RB connected to the merged local network.

In an example, if the merged local network is large in scale, an election packet may be received by an RB after a long time delay, and during the time delay, the status of an RB regarding whether the RB is the DRB may have been changed. Therefore, after the DRB election is finished, it may be further judged whether the DRB in the network may change.

In an example, when an RB determines itself to the DRB, the RB may start a timer. If an election packet is received before the timer times out and the RB determines that itself is not the DRB based on the received election packet, the timer is removed. When the timer times out, the RB determines itself to be the DRB.

The timeout value of the timer may be set according to the needs, e.g., 3 seconds or the like, and this is not restricted by the present disclosure. In an example, the timeout value of the timer may be set to be less than the time needed by an MSTP network to become stable after merging. In an example, if an RB receives an election packet sent by another RB, the RB may prolong the time left of the timer, e.g., when an election packet sent by another RB is received, the time left of the timer may be prolonged on the basis of the initial timeout value, e.g., adding an extra 1 second to the initial 3 seconds. This can give the RBs enough time to elect the correct DRB.

In an example, if the merged local network is not large in scale, the timer may be unnecessary during the DRB election process. After the election is finished, the elected DRB may designate an AVF for a VLAN. If the merged local network is large in scale, the timer may be set, and the AVF is designated for the VLAN by the DRB after the DRB is elected.

In an example, each RB may load in the election packet sent by the RB a VLAN ID of each VLAN enabled on the edge port to facilitate the elected DRB to designate an AVF to the VLAN. After receiving an election packet sent by another RB, an RB may also record information included in the election packet, e.g., a local system ID and a VLAN ID of each enabled VLAN.

When a first RB (i.e., one of RBs) determines the first RB is the DRB, the first RB designates an AVF for each VLAN based on a TRILL designation principle, priorities and the recorded information obtained from election packets sent by second RBs (i.e., other RBs except the first RB). The first RB may then send a packet carrying an AVF designation result (hereinafter simply referred to as designation packet) to inform each of the second RBs of the AVF-VLAN (i.e., the AVF designated to a VLAN) designated for the second RB. As such, each second RB that is not the DRB can get knowledge of the AVF of each VLAN enabled on an edge port of the second RB. In the designation packet sent by the first RB, the local system ID is the local system ID of the second RB the designation packet is destined for.

In an example, after receiving an election packet sent by each second RB, the first RB may judge whether the AVF of a VLAN carried in the election packet is the AVF of the VLAN designated to the second RB. In response to a determination that the AVF of a VLAN carried in the election packet is the AVF of the VLAN designated to the second RB, the first RB stops sending the designation packet to the second RB, and deletes recorded information of the second RB. In response to a determination that the AVF of a VLAN carried in the election packet is not the AVF of the VLAN designated to the second RB, the first RB keeps sending the designation packet to the second RB. This can make sure that the designation packets can be received by the second RBs.

In an example, after the first RB determines that recorded information corresponding to local system IDs of all of the second RBs has been deleted, the first RB removes the AVF inhibiting on the edge port, and stops sending the election packet. After a second RB receives the designation packet and updates an AVF list in the second RB, the second RB removes the AVF inhibiting right away or after a time period or after sending a pre-defined number of election packets.

In an example, when an RB determines itself is not the DRB and receives a designation packet sent by the DRB, the RB may update a local AVF list with the AVF designated for the VLAN in the designation packet if the local system ID in the designation packet is the local system ID of the RB, and continues to send an election packet which carries the AVF designated by the DRB for the VLAN of the RB. After sending a pre-defined number of election packets, the RB may remove all AVF inhibiting on the edge port via which the election packets are sent, and stop sending the election packet. In the designation packet, the local system ID is the local system ID of the RB to which the AVF is designated. As such, the RB can also remove the AVF inhibiting after receiving the designation packet immediately or after waiting for a certain time period.

After the RBs remove the AVF inhibiting, VLAN traffic can be forwarded as normal as long as the MSTP network becomes stable.

In various examples, the election packet and the designation packet may be the same packet or packets defined individually.

An example provides a FAST-AVF packet, and the format is as shown in FIG. 5. The packet format may be applied to the election packet and the designation packet. The packet may include information for DRB election and information for AVF designation. The following is a brief description of the fields in the packet format as shown in FIG. 5. The packet format is merely an example, and not all of the fields are necessary. In other examples, some fields may be omitted, and new fields may be added.

Dest mac (destination mac): the destination MAC address of the packet, may be a multicast MAC address of a spanning tree in an MSTP network that is connected to an edge port of an RB, e.g., 0180-c200-0000.

Source mac: source MAC address of the packet, may be a MAC address of a port of an RB that sends the packet or a MAC address of the RB.

Length: length of the packet, may be 23 bytes from the LLC field to the AVF-Vlan bit-map field.

LLC: logic-link control, which is the same with the LLC field of an STP packet.

Protocol ID: is the same with the protocol ID field in an STP packet.

Protocol version ID: has a value of 5, indicating the packet is a Fast-AVF packet.

DRB-priority: the priority of the elected DRB, the same with DRB-priority field used in the TRILL network, ranging from 0 to 127.

Local system ID: the system ID of the local device.

DRB system ID: the system ID of the elected DRB.

Enabled-Vlan bit-map: a bit-map of all VLANs enabled on a port, a bit representing a VLAN is set to 1 when the VLAN is enabled on the port.

AVF-Vlan bit-map: a bit-map of all AVF-VLANs of a port, a bit representing a VLAN is set to 1 when the port is the AVF of the VLAN.

When two local networks connected to a TRILL network merge with each other, an RB may receive an STP packet indicating a root bridge has changed via an edge port connected with one of the local networks because the root bridge of the MSTP network has changed. The RB may then perform AVF inhibiting in all of VLANs in which the edge port serves as AVF. The RB may also perform AVF inhibiting in a VLAN in which an AVF conflict occurs after receiving a packet indicating the AVF conflict.

Once an edge port of an RB is inhibited, the inhibited edge port may send a Fast-AVF packet according to the above packet format. In the Fast-AVF packet, a local system ID is the device ID of the RB, a DRB system ID is the device ID of the RB, a DRB-priority is the priority of the RB, an Enabled-Vlan bit-map identifies all of VLANs enabled on the edge port, and an AVF-Vlan bit-map identifies all of VLANs in which the edge port serves as AVF. In an example, the DRB-priority is the priority of the elected DRB, and takes the priority of the local RB as its initial value. Conventional TRILL-hello packets are also transmitted. The Fast-AVF packet is sent at pre-defined intervals.

In this example, the destination mac and the protocol version ID fields can serve as the packet identification information, i.e., the values of the two fields are set to be values representing an election packet so that MSTP devices can identify the packet as an election packet from the two fields.

After receiving the election packet, an MSTP device in the local network identifies the packet is a Fast-AVF packet by using the destination mac field and the protocol version ID field in the packet, establishes a Fast-AVF table entry to record information including the source mac, the DRB-priority, the local system ID, the DRB system ID, the enabled-Vlan, the AVF-Vlan and the like. The table entry may be configured to be deleted after 30 s. After that, the MSTP device may flood the packet in a CIST, i.e., forwarding the packet via all the other ports except the port that receives the packet, as long as the ports are UP on the physical layer no matter whether the STP status of the ports is the forwarding status. The MSTP device does not forward a Fast-AVF packet received subsequently when determining the same Fast-AVF packet had been received based on the recorded Fast-AVF table entry.

After the Fast-AVF packet is received by an RB via an edge port, the RB may compare the DRB priority and the DRB system ID in the packet with those of the RB, and select the superior RB (e.g., the DRB in the received packet or the DRB elected by the RB) with a larger value (e.g., a larger DRB priority or a larger DRB system ID) as the elected DRB of the RB. In response to a determination that the information stored in the RB is inferior to the information in the packet, the RB may update the DRB system ID recorded in the RB with the DRB system ID in the packet, reset all the values in the local AVF-Vlan bit-map, and send the local packet of the RB. In the local packet of the RB, the local system ID is the system ID of the RB, the DRB system ID is the DRB system ID in the received packet, the Enabled-Vlan bit-map identifies all of VLANs that are enabled on the edge port, and the AVF-VLAN bit-map is set to be all-zero. In response to a determination that the information stored in the RB is superior to the information in the received packet, the RB may record information about the local system ID and the Enabled-Vlan in the received packet, and send the local Fast-AVF packet of the RB.

When the DRB election is completed, the DRB system ID fields in all of packets sent via edge ports of the RBs bear the same value.

After the DRB election is finished, the AVF-Vlan bit-map fields in Fast-AVF packets sent by edge ports of all of non-DRBs are all-zero. The edge port of the DRB still sends the Fast-AVF packet of the DRB, and the AVF-Vlan bit-map field still bears its initial value.

In an example, each RB assumes itself as the DRB by default when sending its first Fast-AVF packet. Thus, each RB, including the DRB, may start a timer after sending its first Fast-AVF packet. The initial timeout value of the timer may be 3 seconds, or other values configured as needed. Once a different Fast-AVF packet is received, the current life time of the timer is added by 1 second. Once an edge port of an RB becomes a non-DRB, the timer is removed.

Alternatively, only the elected DRB may start a timer after the DRB election is finished to perform the DRB election again.

After the timer times out, the RB may determine itself as the DRB, and perform AVF designation. Since the DRB has recorded information of all the Fast-AVF packets received, the DRB may perform AVF designation based on the recorded information. The designation principles may be similar to those adopted by a DRB in conventional TRILL networks. The DRB may first designate the edge port of the DRB to be the AVF of all VLANs that are enabled on the edge port, and then designate an AVF for each of the other VLANs based on priorities and VLANs enabled on edge ports of other RBs.

After the DRB designation, the DRB may send multiple second Fast-AVF packets to notify other RBs of the AVF designation results while sending the Fast-AVF packet of the DRB. In the second Fast-AVF packet, the local system ID is the system ID of the RB to which the AVF is designated by the second Fast-AVF packet, the DRB system ID is the local system ID of the DRB, the Enabled-Vlan bit-map identifies all of VLANs that are enabled on the edge port of the RB, the most significant bit of the AVF-Vlan bit-map (i.e., the bit whose value is 65536) is set to 1 (indicating the packet is an AVF designation packet sent by the DRB), and bits representing VLANs in which the port is designated as AVF are set to 1.

An RB which is non-DRB may update a local AVF list by using the AVF-Vlan bit-map in the received packet in which the most significant bit of the AVF-Vlan bit-map is set to 1, and send an updated local Fast-AVF packet. In the updated local Fast-AVF packet sent by the RB, the local system ID is the device ID of the RB, the DRB system ID is the system ID of the DRB, the Enabled-Vlan bit-map identifies all of VLANs that are enabled on the edge port of the RB, and the AVF-Vlan bit-map identifies the updated AVF VLAN value, i.e., the VLANs in which the edge port serves as the AVF. After sending 3 Fast-AVF packets, the RB may remove all of AVF inhibiting on the edge port. Once AVF inhibiting is removed from a port of a non-DRB, the Fast-AVF packet is not sent any more. Conventional TRILL hello packets may still be sent as normal.

Once the DRB receives an updated Fast-AVF packet sent by a non-DRB, the DRB may judge whether the AVF-Vlan bit-map in the packet is identical to the AVF-Vlan bit-map designated for the non-DRB. In response to a determination that the AVF-Vlan bit-maps are identical, the DRB stops sending the second Fast-AVF packet for AVF designation to the RB, and deletes system ID information of the RB recorded in the DRB. In response to a determination that the AVF-Vlan bit-maps are not identical, the DRB continues sending the second Fast-AVF packet for AVF designation.

After deleting all of information corresponding to system IDs of other RBs stored in the DRB, the DRB may remove all AVF inhibiting on the edge port of the DRB, and stops sending the Fast-AVF packet of the DRB. Conventional TRILL hello packets may still be sent as normal.

It can be seen that by using the Fast-AVF packets, a DRB can be quickly elected from among RBs connected to two local networks that are connected to a TRILL network and are merging with each other, and AVF can be quickly designated. As such, VLAN traffic interruption resulted from AVF inhibiting in RBs after the MSTP network becomes stable can be avoided.

The above examples are based on an MSTP network, and a similar process can be applied to STP networks and RSTP networks with packets being flooded in respective spanning trees by STP devices in STP networks or by RSTP devices in RSTP networks, and the details will not be elaborated herein.

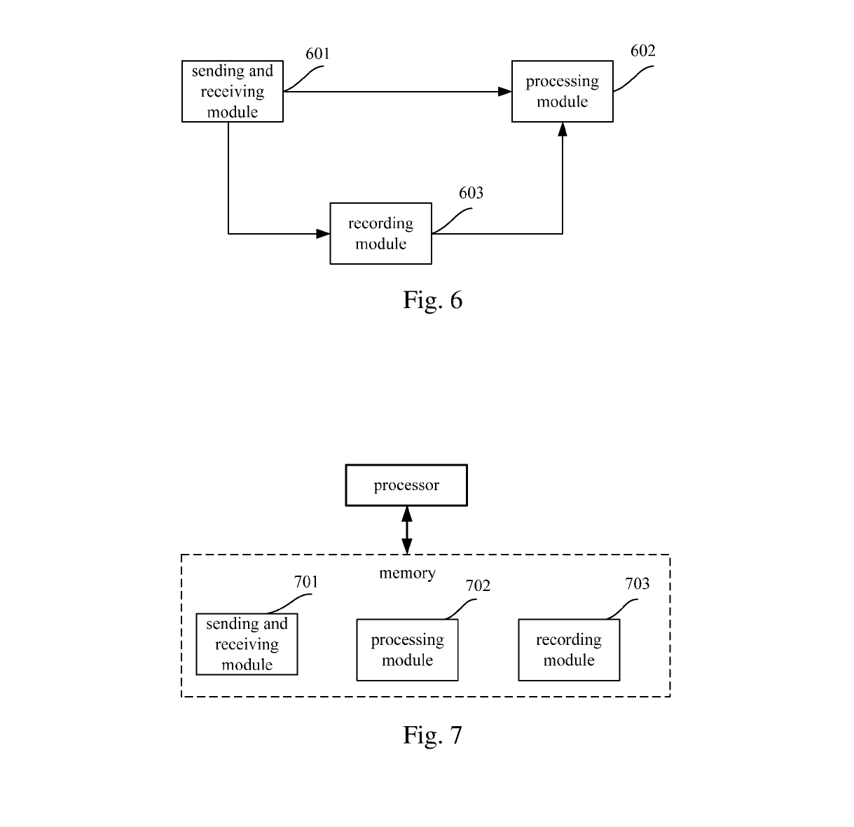

Examples of the present disclosure also provide an apparatus. The apparatus can be applied to RBs connected to local networks that are connected to a TRILL network and are merging with each other. FIG. 6 is a schematic diagram illustrating modules of the apparatus in accordance with an example of the present disclosure. The apparatus may include a sending and receiving module 601 and a processing module 602.

The sending and receiving module 601 sends a first election packet via an edge port to which AVF inhibiting is applied to make an STP device in a local network to flood the first election packet in a spanning tree, and receives a second election packet forwarded by an STP device via the edge port.

The processing module 602 performs DRB election after the sending and receiving module 601 receives the second election packet forwarded by the STP device via the edge port.

In an example, the local network may be a regular STP network, or an MSTP network or an RSTP network. Detailed implementation in the MSTP network or the RSTP network is similar to the above described method, and will not be elaborated herein.

In an example, the processing module 602 may compare a DRB priority in the second election packet with a DRB priority of the apparatus after the sending and receiving module 601 receives the second election packet.

In an example, the processing module may determine the apparatus is not a DRB in response to a determination that the DRB priority in the second election packet is larger than the DRB priority of the apparatus, and update a DRB system ID in the first election packet to be sent by the apparatus with the DRB system ID in the second election packet, and send the first election packet; determine the apparatus is the DRB in response to a determination that the DRB priority in the second election packet is smaller than the DRB priority of the apparatus, continue to send the first election packet; judge whether the DRB system ID is larger than a local system ID of the apparatus in response to a determination that the DRB priority in the second election packet is identical to the DRB priority of the apparatus; update the DRB system ID in the first election packet to be sent by the apparatus with the DRB system ID in the second selection packet in response to a determination that the DRB system ID is larger than the local system ID of the apparatus, and send the first election packet; continue to send the first election packet in response to a determination that the DRB system ID is smaller than the local system ID of the apparatus. The first election packet includes the DRB priority which is the priority of the apparatus or the priority of a DRB elected by the apparatus, the DRB system ID which is the system ID of the DRB elected by the apparatus, and a local system ID which is the system ID of the apparatus.

In an example, the processing module 602 may start a timer when determining the apparatus is the DRB, remove the timer if an election packet is received within the timeout period of the timer and the processing module 602 determines the apparatus is not the DRB based on the received election packet; and determine the apparatus is the DRB when the timer times out.

In an example, the apparatus may also include a recording module 603.

The recording module 603 may record information in the second election packet after the sending and receiving module 601 receives the second election packet via the edge port. The recorded information may include a local system ID and VLAN IDs of all of enabled VLANs in the second election packet.

The processing module 602 may also designate an AVF for each VLAN based on a TRILL designation principle and information of election packets recorded by the recording module 603 when determining the apparatus is the DRB.

The sending and receiving module 601 may send a designation packet to inform each RB of an AVF of each Vlan designated by the processing module 602 for each RB to make each RB that is not the DRB obtain knowledge of the AVF of each VLAN enabled on an edge port of the RB.

In an example, the processing module 602 may determine whether an AVF of a VLAN in an election packet received by the sending and receiving module 601 from an RB is identical to the AVF of the VLAN designated by the apparatus for the RB when determining the apparatus is the DRB, instruct the sending and receiving module 601 to stop sending the designation packet to the RB and deleting recorded information of the RB in response to a determination that the AVF of the VLAN in the election packet received by the sending and receiving module 601 from the RB is identical to the AVF of the VLAN designated by the apparatus for the RB; and instruct the sending and receiving module 601 to continue sending the designation packet to the RB in response to a determination that the AVF of the VLAN in the election packet received by the sending and receiving module 601 from the RB is not identical to the AVF of the VLAN designated by the apparatus for the RB.

In an example, the processing module 602 may remove all of AVF inhibiting on the edge port via which the first election packet is sent and instruct the sending and receiving module 601 to stop sending the first election packet when determining the apparatus is the DRB and all of recorded information of local system IDs of RBs that are not the DRB has been deleted.

In an example, the processing module 602 may update a local AVF list with an AVF designated for a VLAN in a designation packet received by the sending and receiving module 601 from the DRB and instruct the sending and receiving module to send the first election packet which includes the AVF designated by the DRB for the VLAN if determining the apparatus is not the DRB and a local system ID in the designation packet received is the local system ID of the apparatus, and remove all of AVF inhibiting on the edge port via which the first election packet is sent and instruct the sending and receiving module 601 to stop sending the first election packet after the first election packet has been sent for a pre-defined number of times. In the designation packet, a local system ID is the local system ID of an RB to which the AVF of the VLAN is designated.

Examples of the present disclosure provide a system applicable to multiple local networks connected to a TRILL network. The system may include plural RBs and plural STP devices.

The RB is connected to one of the local networks, may send a first election packet via an edge port to which AVF inhibiting is applied, and perform DRB election by using a second election packet forwarded by one of the STP devices via the edge port.

The STP device is located in a local network, may receive the first election packet sent by the RB, and flood the first election packet in a spanning tree.

FIG. 7 is a schematic diagram illustrating modules of a device in accordance with an example of the present disclosure. As shown in FIG. 7, the apparatus may include a processor and a memory. The memory stores a series of machine-readable instructions which may cause the processor to implement methods of various examples of the present disclosure.

For example, the memory may store machine-readable instructions corresponding to a sending and receiving module 701, a processing module 702 and a recording module 703. Functions of the sending and receiving module 701, the processing module 702 and the recording module 703 are the same or similar with functions of the above sending and receiving module 601, the processing module 602 and the recording module 603.

In an example, the STP network may be a regular STP network, or an RSTP network or an MSTP network. The STP device may be a regular STP device, or an RSTP device or an MSTP device.

The modules may be deployed into one entity, or be deployed individually; may be integrated into one module, or be divided into multiple sub modules.

In view of the foregoing, DRB election is implemented by using election packets received when AVF inhibiting is applied to an edge port of an RB. As such, a DRB can be quickly determined when AVF inhibiting is applied to an edge port.

Various examples also provide a mechanism for designating an AVF-Vlan for each non-DRB after the DRB is determined, thus avoid interruption of local network traffic resulted from not designated AVF and thus can make the network stable.

It should be understood that in the above processes and structures, not all of the procedures and modules are necessary. Certain procedures or modules may be omitted according to the needs. The order of the procedures is not fixed, and can be adjusted according to the needs. The modules are defined based on function simply for facilitating description. In implementation, a module may be implemented by multiple modules, and functions of multiple modules may be implemented by the same module. The modules may reside in the same device or distribute in different devices. The “first”, “second” in the above descriptions are merely for distinguishing two similar objects, and have no substantial meanings.

The hardware modules according to various examples may be implemented by hardware or a hardware platform with necessary software. The software may include machine-readable instructions which are stored in a non-statutory storage medium. Thus, the examples may be embodied as software products.

In various examples, the hardware may be dedicated hardware or general-purpose hardware executing machine-readable instruction. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A module may also comprise programmable logic or circuitry (e.g., as encompassed within a general-purpose processor or other programmable processor) that is temporarily configured by software to perform certain operations.

The machine-readable instructions corresponding to modules 701-703 as shown in FIG. 7 may cause an operating system running in a computer to implement part or all of the operations described herein. A non-statutory computer-readable storage medium may be a storage device in an extension board inserted in the computer or a storage in an extension unit connected to the computer. In this example, a CPU in the extension board or the extension unit executes at least part of the operations according to the instructions based on the program codes to realize the technical scheme of any of the above examples.

The non-statutory computer-readable storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the embodiments set forth in the examples, but should be given the broadest interpretation consistent with the description as a whole.

1. A method of electing a designated routing bridge (DRB), comprising:
sending, by a routing bridge (RB) in a Transparent Interconnection of Lots of Links (TRILL) network, a first election packet for DRB election via an edge port of the RB that is connected to a local network after detecting appointed VLAN-x forwarder (AVF) inhibiting is applied to the edge port, to cause a spanning tree protocol (STP) device in the STP network to flood the first election packet in a spanning tree in the STP network; and
receiving, by the RB, a second election packet forwarded by an STP device via the edge port, and performing DRB election based on the second election packet.

2. The method of claim 1, wherein the first election packet sent by the RB comprises a local system ID which is a system ID of the RB, a priority of a first DRB elected by the RB, and a DRB system ID which is a system ID of the first elected DRB;
wherein receiving by the RB a second election packet forwarded by an STP device via the edge port and performing DRB election based on the second election packet comprises:
comparing, by the RB, a priority of a second DRB in the second election packet with the priority of the first DRB elected by the RB after receiving the second election packet;
updating the priority of the first DRB in the first election packet to be sent by the RB with the priority of the second DRB in the second election packet and updating the system ID of the first DRB in the first election packet to be sent by the RB with a system ID of the second DRB in the second election packet and sending the first election packet in response to a determination that the priority of the second DRB is larger than the priority of the first DRB;
judging whether the system ID of the second DRB is larger than the system ID of the first DRB in response to a determination that the priority of the second DRB is identical to the priority of the first DRB; updating the system ID of the first DRB in the first election packet to be sent by the RB with the system ID of the second DRB in the second election packet and sending the first election packet in response to a determination that the system ID of the second DRB is larger than the system ID of the first DRB.

3. The method of claim 1, further comprising:
starting, by the RB, a timer if the RB determines the RB is a DRB; deleting, by the RB, the timer if a third election packet is received before the timer times out and the RB determines the RB is not the DRB; determining the RB is the DRB when the timer times out.

4. The method of claim 3, further comprising: recording information in the second election packet after receiving the second election packet via the edge port, wherein the information recorded comprises: a local system ID and VLAN IDs of all of enabled VLANs in the second election packet;
designating, by the RB, an AVF for each VLAN based on a TRILL designation principle and the recorded information, sending a designation packet to inform each second RB of the plural RBs that is not the DRB of the AVF of each Vlan designated for the second RB so that each second RB gets knowledge of the AVF of each VLAN enabled on an edge port of the second RB after the RB determines the RB is the DRB.

5. The method of claim 4, further comprising:
receiving, by the RB when determining the RB is the DRB, a third election packet sent by a third RB which is not the DRB, judging whether an AVF of a VLAN in the third election packet is identical to an AVF designated to the VLAN for the third RB by the RB, stopping sending a designation packet to the third RB and deleting recorded information of the third RB in response to a determination that the AVF of the VLAN in the third election packet is identical to the AVF designated to the VLAN for the third RB; continuing sending the designation packet to the third RB.

6. The method of claim 5, further comprising:
removing, by the first RB when determining the RB is the DRB, the AVF inhibiting on the edge port and stops sending the first election packet after determining that recorded information corresponding to local system IDs of all of the second RBs that are not the DRB has been deleted.

7. The method of claim 3, further comprising:
receiving, by the RB when determining the RB is not the DRB, a second designation packet sent by the DRB, updating a local AVF list and continuing sending the first election packet which comprises an AVF designated to a VLAN for the RB by the DRB in response to a determination that a local system ID in the second designation packet is the local system ID of the RB;
removing, by the RB, the AVF inhibiting on the edge port and stopping sending the first election packet after the first election packet has been sent for a pre-defined number of times; wherein the local system ID in the second designation packet is the local system ID of the RB.

8. The method of claim 1, wherein the first election packet sent by the RB comprises packet identification information which enables an STP device to identify the first election packet.

9. An apparatus, capable of acting as a routing bridge (RB) to connect a local network with a transparent interconnection of lots of links (TRILL) network, the apparatus comprising:
a sending and receiving module to send a first election packet via an edge port to which appointed VLAN-x forwarder (AVF) inhibiting is applied to cause a spanning tree protocol (STP) device in a local network to flood the first election packet in a spanning tree, and receiving a second election packet forwarded by an STP device via the edge port; and
a processing module to perform designated routing bridge (DRB) election based on the second election packet, after the sending and receiving module receives the second election packet forwarded by the STP device via the edge port.

10. The apparatus of claim 9, wherein the processing module is to compare a priority of a first DRB elected by the apparatus with a priority of a second DRB in the second election packet after the sending and receiving module receives the second election packet forwarded by the STP device; and
to update the priority of the first DRB in the first election packet to be sent by the RB with the priority of the second DRB in the second election packet and update a DRB system ID which is a system ID of the first DRB in the first election packet to be sent by the apparatus with a system ID of the second DRB in the second election packet and to send the first election packet in response to a determination that the priority of the second DRB is larger than the priority of the first DRB; to judge whether the system ID of the second DRB in the second election packet is larger than the system ID of the first DRB in response to a determination that the priority of the second DRB is identical to the priority of the first DRB; to update the DRB system ID in the first election packet to be sent by the apparatus with the system ID of the second DRB in the second election packet and to send the first election packet in response to a determination that the system ID of the second DRB is larger than the system ID of the first DRB;
wherein the first election packet to be sent by the apparatus comprises a local system ID which is a system ID of the apparatus, a priority of a DRB elected by the apparatus, the DRB system ID which is a system ID of the DRB elected by the apparatus.

11. The apparatus of claim 9, wherein
the processing module is further to start a timer when determining the apparatus is the DRB, to remove the timer if a third election packet is received before the timer times out and the processing module determines the apparatus is not the DRB based on the third election packet; and to determine the apparatus is the DRB when the timer times out.

12. The apparatus of claim 11, further comprising:
a recording module, to record information in the second election packet after the sending and receiving module receives the second election packet via the edge port; wherein the information recorded comprises a local system ID and VLAN IDs of all of enabled VLANs in the second election packet; and
the processing module is further to designate an AVF for each VLAN based on a TRILL designation principle and information recorded by the recording module when determining the apparatus is the DRB; and
the sending and receiving module is to send a designation packet to inform each RB of the AVF designated to each VLAN for each RB by the processing module to make each RB that is not the DRB get knowledge of the AVF of each VLAN enabled on an edge port of the RB.

13. The apparatus of claim 12, wherein
the processing module is further to determine whether an AVF of a VLAN in a third election packet received by the sending and receiving module from an RB is identical to an AVF designated by the apparatus to the VLAN for the RB when determining the apparatus is the DRB, to instruct the sending and receiving module to stop sending the designation packet to the RB and to delete recorded information of the RB in response to a determination that the AVF of the VLAN in the third election packet received by the sending and receiving module from the RB is identical to the AVF designated by the apparatus to the VLAN for the RB; and to instruct the sending and receiving module to continue sending the designation packet to the RB in response to a determination that the AVF of the VLAN in the election packet received by the sending and receiving module from the RB is not identical to the AVF designated by the apparatus to the VLAN for the RB.

14. The apparatus of claim 11, wherein
the processing module is further to update a local AVF list with an AVF designated to a VLAN in a designation packet received by the sending and receiving module from the DRB and to instruct the sending and receiving module to send the first election packet which includes the AVF designated by the DRB to the VLAN if determining the apparatus is not the DRB and a local system ID in the designation packet received is the local system ID of the apparatus, and to remove all of AVF inhibiting on the edge port via which the first election packet is sent and to instruct the sending and receiving module to stop sending the first election packet after a pre-defined number of the first election packets have been sent; wherein a local system ID in the designation packet is the local system ID of an RB to which the AVF is designated.

15. A system, applicable to multiple local networks connected to a Transparent Interconnection of Lots of Links (TRILL) network, the system comprising: plural routing bridges (RB) and plural spanning tree protocol (STP) devices; wherein
each of the plural RBs is connected to one of the multiple local networks, and is to send a first election packet via an edge port to which appointed VLAN-x forwarder (AVF) inhibiting is applied, and to perform DRB election by using a second election packet forwarded by one of the STP devices via the edge port; and
each of the plural STP devices is located in one of the multiple local networks, and is to receive the first election packet sent by the RB, and flood the first election packet in a spanning tree.
